(19) United States
(12) Patent Application Publication
(10) Pub. No.: US 2024/0210357 A1
(43) Pub. Date: Jun. 27, 2024

(54) Method for Testing the Quality of Ultrasonic Welded Joints

(71) Applicant: XARION Laser Acoustics GmbH, Wien (AT)

(72) Inventors: Georg Kaniak, Vienna (AT); Balthasar Fischer, Vienna (AT)

(21) Appl. No.: 18/391,610

(22) Filed: Dec. 20, 2023

(30) Foreign Application Priority Data
Dec. 21, 2022 (EP) 22215269

(51) Int. Cl. G01N 29/04; B23K 20/10

(52) U.S. Cl. CPC G01N 29/04; B23K 20/10; G01N 2291/023; G01N 2291/267

(57) ABSTRACT

The invention relates to a method for testing the quality of an ultrasonic welded joint during the creation of the ultrasonic welded joint using a vibration pickup device, and a computing device comprising the following steps: Detecting vibration signals using the vibration pickup device; creating electric measuring signals in the vibration pickup device on the basis of the detected vibration signals; transmitting the electric measuring signals the computing device; processing a signal block of the electric measuring signals in the computing device; computing a characteristic value on the basis of the signal block of the electric measuring signals; comparing the a characteristic value with a reference value in the computing device; determining information, which is indicative for the quality of the ultrasonic welded joint, based on the comparison of the characteristic value with the reference value. The invention further relates to a measuring apparatus.

### BACKGROUND OF THE INVENTION

Ultrasonic welding uses the frictional heat, between a transducer (also referred to as sonotrode) and at least two workpiece parts, which are to be welded together, in order to heat up the two surfaces of the workpiece so far, so that a welded joint is created. The frequency of the transducer thereby typically lies in the ultrasonic range starting at 20 kHz and above. In the case of an appropriate preparation of the two workpiece parts, consistently good results with regard to the welded joint can be attained using this joining method. There are influencing factors, however, such as the contamination of the surface of the workpiece parts by oils, moisture, finger prints, worn tools, unsuitable contact pressures, incorrect positionings, or a holding force, which is too small, of the clamping of the workpieces, which can negatively impact the quality of the welded joint. To continuously monitor these influencing factors or deviations in the holding force serves the purpose of detecting otherwise undetected errors.

DE102013222876 A1 is known from the prior art. A vibration welding system is disclosed there, which comprises a welding robot comprising a vibration welding device, a welding horn, and a control station, which is designed to form a welded seam on a workpiece clamped between the welding horn and a welding anvil. The rotor rotates or moves the welding horn and the anvil at prescribed intervals to a control station, e.g., by pivoting from a process conveyor belt to the control station once per layer. A host computing device and several sensors are present in the vibration welding system, wherein the sensors comprise an acoustic sensor. The host computing device is designed to transfer a prerecorded acoustic baseline signal to the acoustic sensor, to record the transferred prerecorded acoustic baseline signal via the acoustic sensor, and to compare the recorded signal with the prerecorded acoustic baseline signal, in order to determine a signal fluctuation.

It is a disadvantage of the known solution that the host computing device evaluates individual steps of the method at regularly prescribed intervals, wherein the workpiece leaves the production line. A gap-free real time monitoring of the welded joints on the workpiece in the process is thus not at hand.

DE102019134555A1 is known from the prior art. The disclosed system has a sound sensor, an electronic sensor, and an evaluation unit, wherein the sound sensor is formed to measure values of a structure-borne sound of the component during the welding. The electronic sensor is formed to measure values of at least one electric operating parameter during the welding process or during the welding, respectively. The evaluation unit is formed to evaluate the welded seam on the basis of the measured values. The sound sensor is formed to also measure values of a structure-borne sound of at least one component of the welding device, in addition to values for the frequency and/or amplitude of the structure-borne sound of the component. A warning signal is generated when at least one measured value of the frequency and/or of the amplitude of the structure-borne sound, of the current and/or of the voltage deviates by a tolerance value, which is in each case provided for this purpose, from a target value, which is in each case provided for this purpose, whereby it is provided that the welding process is cancelled, depending on the deviation of an actual value from the respective target value.

It is a disadvantage of the known solution that a quality determination of the welded seam does not take place but a welding process is only cancelled when a tolerance value is exceeded.

US2019271669A1 is known from the prior art. What is described are methods, systems, and non-volatile computer-readable storage media with programs for monitoring an ultrasonic joining process using acoustic and/or vibration measurements and for the analysis of the measurements, in order to predict the quality of a welded seam resulting therefrom.

DE102019109264A1 is known from the prior art. A method for the quality monitoring during the ultrasonic welding is disclosed there, wherein the vibration behavior with respect to an actual value of the vibration frequency and/or of the vibration amplitude of at least one involved joining partner is determined during the joining process. A measuring device is furthermore disclosed, which is formed for the quantification of mechanical vibrations. The detected vibration behavior is determined using a Fourier analysis and is compared with a specified target value as reference value.

DE102015120165A1 is known from the prior art. It discloses a device and a method for monitoring and/or determining the purity and joining quality of a joint of two joining partners created using an ultrasonic welding. The vibration behavior during the joining process with regard to an actual value of the vibration frequency and/or the vibration amplitude of at least one joining partner involved in the joining process and/or of a tool of an ultrasonic welding device used during the joining process is detected thereby by measuring with at least one measuring device and is compared with a predetermined target value as reference value. The measuring device, a laser vibrometer, is formed for the quantification of the mechanical vibrations.

Disadvantages of the known solutions are that the evaluation methods of the measuring signals with regard to the vibration behaviors only take place in a rudimentary manner and the accuracy of the evaluations can thus not be attained for industrial ultrasonic welded joints, so that a usable quality determination of ultrasonic welded joints is not possible. Only a simple and cost-efficient monitoring option is disclosed.

### SUMMARY OF THE INVENTION

The present invention relates to a method for testing the quality of at least one ultrasonic welded joint, a measuring apparatus and a computer program.

It is an object of the invention to avoid at least one of the disadvantages of the prior art, in particular an improved real time monitoring of the creation of an ultrasonic welded joint is to be provided in order to ensure an improved quality determination of the holding force of the ultrasonic welded joint in the welding process.

This object is solved using the features of the independent patent claims. Advantageous further developments are specified in the figures and in the dependent patent claims.

A method according to the invention for testing the quality of at least one ultrasonic welded joint during the creation of the ultrasonic welded joint at least one workpiece, using at least one vibration pickup device, and a computing device can include at least the following steps:
a) detecting vibration signals using the at least one vibration pickup device, wherein the vibration signals are influenced by at least one component of an ultrasonic welding device and the at least one workpiece;
b) creating electric measuring signals in the vibration pickup device on the basis of the detected vibration signals;
c) transmitting the electric measuring signals to the computing device;
d) processing at least one signal block of the electric measuring signals in the computing device;
e) computing at least one characteristic value on the basis of the at least one signal block of the electric measuring signals;
f) comparing the at least one characteristic value with at least one reference value in the computing device; and
g) determining information, which is indicative for the quality of the ultrasonic welded joint, based on the comparison of the at least one characteristic value with the at least one reference value.

The work behavior of an ultrasonic welding device can be tested therewith continuously and automatically, in a gap-free manner in real time, in the process, whereby an improved quality determination of the holding force of the ultrasonic welded joint is ensured in the process. The preferably continuously detected vibration signals can comprise airborne sound signals or structure-borne sound signal or can result from a current or voltage measurement of at least one piezoelectric actuator. The information, which is indicative for the quality of the ultrasonic welded joint comprises, for example, the information of a welded joint for a reusable workpiece (OK workpiece) or of a welded joint for a non-reusable workpiece (NOK workpiece). Whether or not a workpiece can be reused for the intended use thereof is typically tested beforehand with the help of a pulling test (destructive test method) for the ultrasonic welded joint at an external test device. The vibration signals or the electric measuring signals thereof, respectively, or signal blocks of an OK workpiece can subsequently be stored as reference value in the computing device, for example as table value, in order to compare them with the computed characteristic values in the computing device in the process. The present method makes a subsequent pulling test at the workpiece obsolete. The classification of the created workpieces comprising an ultrasonic welded joint into two categories (good or bad, or OK or nOK, respectively) leads to a quick decision in the production process, so that an increased production cycle and thus an increased process performance is possible. The classification into OK and nOK is in particular bound to the holding force of the ultrasonic welded joint, for example, an ultrasonic welded joint with a holding force of >200 Newton can be considered to be good (OK), and an ultrasonic welded joint with a holding force of <100 Newton to be bad (nOK). The limit values are different, depending on application and material, and can range from a few Newton to several kilonewton. A subdivision into subclasses is also possible sometimes, where ultrasonic welded joints are divided into various classes, e.g., <50N; 50-100N; 100-200N, etc. The Newton value or the force, respectively, can currently only be determined in destructive test (pull test). A method is thus provided, which predicts the holding force of the ultrasonic welded joint in a destruction-free manner. Ideally, the predicted holding force of the ultrasonic welded joint is additionally output immediately after the production of the welding (within one second), and not only as a result of a downstream, separate, external test.

An ultrasonic welding device can be used in order to form welded joints at an originally two-part workpiece, wherein a first part of the workpiece can be a stranded wire typically made of copper or aluminum, and a second part of the workpiece can be a terminal made of materials, such as copper, brass comprising coatings. The two-part workpiece can likewise be massive metal parts, such as sleeves, or also plastic parts. A typical ultrasonic welding process of stranded wires on a terminal consist of a precompacting, the main sound, as well as a pulse for separating the sonotrode from the workpiece. Information relating to the quality of the welding can be contained in the signal of the main sound as well as in the signal of the precompacting and can be evaluated using the methods, which are present here. At least two of the three process steps can thus be evaluated during the ultrasonic welding, so that an improved determination of the indicative information, which is relevant for the quality of the ultrasonic welded joint, is made possible.

The ultrasonic welding device typically comprises a converter, a booster, a generator, and a sonotrode. For the present method, at least the sonotrode, together with the workpiece, forms a mechanical vibration system, which effects a change of the vibration signals. The fundamental frequency of the vibration signal typically lies at 20 kHz but can also lie at higher (up to 100 kHz or above) or lower frequencies (several kHz or below). Higher harmonics are created simultaneously, as multiple n of the fundamental frequency, whereby n can assume one or several arbitrary, integers 1, 2, 3, . . . Overtones or harmonics can advance all the way into the frequency range of several 100 kHz. Sum and differential frequencies are further created, so that a complex and temporally changing frequency spectrum results through the vibration system. The vibration behavior of this system can be influenced by different influences, such as, for example, size of the workpiece, a contact pressure of the sonotrode on the workpiece, a temperature of the sonotrode, a vibration amplitude of the sonotrode, material combinations, but also surface contaminations on the workpiece, or a clamping of the workpiece (position and/or force). These changes of the vibration behavior can be indicators for a change of the quality of the welded joint.

Several vibration signals of ultrasonic welding processes can be recorded beforehand and can be stored as reference values for welding processes with desired result (OK workpiece) in a storge device as table values under controlled conditions and can be queried by the computing device.

In particular, an output of at least one warning signal takes place after the step g). An acoustic or a visual warning signal, which is output or displayed at a display device, can be provided as warning signal. An OK workpiece or an NOK workpiece can thus be tested in real time in the process, and the result can be reported directly to a user. The type or output of the warning signal can be dependent on the indicative information, so that it can be recognized on the basis of the warning signal, whether the workpiece, the welding of which was just finished, is NOK or OK. During or after the testing of the workpiece, the computing device can prompt the display device to display the warning signal, which represents an NOK workpiece or an OK workpiece, a user can thus recognize the quality of the welded joint immediately.

A computing device in particular generates control data for the control device of the ultrasonic welding device, wherein the control data control the further transport of the welded workpiece. The computing device can, for example, prompt the control device to control a workpiece transporting device of the ultrasonic welding device in such a way that an NOK workpiece is ejected and an nOK workpiece is thus no longer used in the further processing process. Resources are thus saved.

At least two vibration signals are in particular detected in a single region or a single position, wherein said single region or single position is spaced apart from the at least one component of the ultrasonic welding device and the at least one workpiece. The vibration signals or the acoustic signals, respectively, which are significant for the monitoring of the quality of the welding process, are typically radiated at different positions and in different directions by the at least one component of the ultrasonic welding device and the at least one workpiece. These positions lie several 10 centimeters away from one another, in the region of the sonotrode. The above-mentioned single region is at least smaller than 20 centimeters, wherein the vibration pickup device is in particular positioned in this single region and detects the at least two vibration signals. It is essential for a stable and reliable quality monitoring of the welding process that all of the vibration signals or the entire acoustics, respectively, are monitored simultaneously. Due to the fact that the airborne sound and thus the vibration signals typically overlap or a superposition is present, respectively, a single vibration pickup device can thus monitor the entire ultrasonic welding process in a single region or at a single position, respectively, spaced apart from the at least one component of the ultrasonic welding device and the at least one workpiece.

The transmitted electric measuring signals are preferably temporally scanned with the help of the computing device. The electric measuring signal is thus processed in a quantized manner, so that the electric measuring signal can be processed with an improved signal quality.

The polarity of the electric measuring signals is in particular evaluated in the computing device. The electric measuring signals are thereby divided into binary signals, in >0 or <=0, depending on the polarity. Signal parts of the vibration signal, which are not required, are thus disregarded and the electric measuring signals can be further processed in a simplified manner in the computing device.

In a further embodiment, the electric measuring signals are divided into signal blocks. The electric measuring signals are thus further quantized, in order to be simplified in the computing device, and to be better reusable compared to the continuous vibration signals. The signal length of a signal block is in particular less than 100 ms. The divided signal blocks in particular do not overlap, so that a distortion of the information, which is indicative for the quality of the welded joint, is prevented. The first divided signal blocks are preferably discarded and are not used for the further evaluation in the following steps, so that initial measuring uncertainties are disregarded and do not contribute to the quality of the information, which is indicative for the welded joint.

A Fourier transformation (FT) with at least the one processed signal block is preferably carried out in step d). The at least one signal block is thereby broken down into its component parts. These component parts can be individual sine waves at discrete frequencies, the amplitude and phase of which are determined. The FT thus allows for an improved view onto a signal in the frequency range. The created FT coefficients of the transformed vibration signal can subsequently be further processed and evaluated easily. The FT breaks down a signal into individual spectral components and thus gives information about its composition. The vibration signal can thus be broken down in its entirety or can be subjected to a time-frequency transformation, for instance a Fourier transformation, or different variations of the wavelet transformation, broken down into blocks as binary signal or amplitude signal. In step d), for example, the Fourier transformation (FT) is carried out in the form of a fast Fourier transformation (FFT) or a short-time Fourier transformation (STFT) with at least the one processed signal block. The created FT coefficients of the transformed vibration signal are in particular used to obtain feature vectors, which serve as base for machine learning algorithms in an AI (artificial intelligence) module. The AI module can subsequently provide the at least one characteristic value. In general, the AI module serves the purpose of constructing a statistical model, which is based on training data and which is tested by using test data, in order to ultimately be used for the data of running weldings in the production process. The usable algorithms are to in particular be understood as monitored (supervised) ML algorithms, in the case of which a model, which is applied to further evaluation data in order to compute a classification (OK v. NOK) or a regression (estimation of a continuous value—for instance, the force value of a destructive test), is trained using a training data set. Deep learning (artificial neuronal networks) where several layers of artificial neurons link the input variables (feature vector) to the output variable (classification, regression.), are to be named among the approaches for training such models. In addition to numerous other machine learning methods, random forest algorithms (randomized decision trees) or support vector machines (estimation using support vectors in the vector space of the feature vectors) can likewise be used, in particular in order to limit the computing effort. For example, the generated FT coefficients for welded joints of OK workpieces are generated and are provided to the AI module as AI training data. It is thus possible using the model trained in this way to predict for further vibration signals whether the removal force comes to lie above or below a specified tolerance range or reference value, respectively. The AI module can thus supply essential parameters for assessing OK workpieces or nOK workpieces.

In a further embodiment, a Hilbert transformation with at least the one processed signal block is carried out in step d). The at least one transformed signal block is in particular transmitted to an AI module or is in particular transmitted to a regression module.

In a further embodiment, a continuous wavelet transformation is carried out in step d) with at least the one processed signal block. The at least one transformed signal block is in particular transmitted to an AI module or is transmitted in particular to a regression module.

In a further embodiment, a Cepstrum transformation is carried out with at least the one processed signal block. The at least one transformed signal block is in particular transmitted to an AI module or is in particular transmitted to a regression module.

In step d) the at least one signal block is in particular transmitted to an AI module. The at least one signal block is thereby used to obtain feature vectors, which serve as basis for machine learning algorithms in the AI (artificial intelligence) module. The AI module can subsequently provide the at least one characteristic value. For example, reference measurements for welded joints of OK workpieces are generated and are provided to the AI module as AI training data. If classifying machine learning is used thereby and if a destructive removal test is performed at the workpieces for a number of reference measurements (with good and decreased detachment force), it is thus possible to make a prediction for further vibration signals using the model trained in this way, whether the removal force comes to lie above or below a specified tolerance range or reference value, respectively. The AI module can thus supply essential parameters for assessing OK workpieces or nOK workpieces.

Alternatively or additionally, the at least one signal block is transmitted to a regression module in step d). The regression model can be trained in such a way that an expected force value of the destructive test is estimated as continuous value in the removal test. This continuous value, in turn, can be stored as reference value in a table in the storage device.

In a further embodiment, one or several maximum values in the transformed signal block are detected in order to reuse them in particular either individually or to be able to provide them to the AI module as training data. A maximum is preferably searched for in the surrounding area (around a delta) of a signal block value of the transformed signal block, so that the evaluation of the welded joints on the workpiece can be carried out with an improved resolution.

An analysis curve is in particular created on the basis of the transformed signal block. The analysis curve represents a characteristic curve of the transformed signal block and can be easily evaluated and can be easily compared to empirical values, which improves the resolution in the evaluation using the computing device.

A differential curve is preferably created between the analysis curve and a first reference curve. The first reference curve can thereby comprise data of an ultrasonic welded joint of an OK workpiece, so that the differential curve has differential values around zero. An OK workpiece can thus be tested easily and reproducibly. The first reference curve can be stored in the storage device and can be queried by the computing device.

The at least one characteristic value is in particular generated with the help of the differential curve. A single value is thus relevant for the assessment of the information, which is indicative for the quality of the ultrasonic welded joint, so that the decision-making process is simplified and the process can be carried out quickly. When exceeding the at least one characteristic value compared to the reference value, the welding is qualified as nOK workpiece or as being faulty, respectively, or is qualified as OK workpiece or fault-free, respectively, when falling below.

The at least one characteristic value can in particular be a measure for the deviation from the reference curve. By adding or subtracting an offset, the decision threshold can be shifted in order to set the system to be more tolerant or more sensitive in the case of already trained model.

A tolerance range is in particular provided in the comparison, so that several OK workpieces can be reused. The tolerance range preferably comprises up to 10% tolerance compared to the at least one characteristic value with the reference value, so that workpieces with a deviation of up to 10% (tolerance) can still be reused as OK workpieces in the above-described comparison.

In a further embodiment, the vibration signals comprise a frequency of an airborne sound signal. The sonotrode of the ultrasonic welding device typically vibrates, driven by piezoelectric elements, at a specified frequency, at 20 kHz as well as the corresponding harmonics. The quality of the welded joint can thus be easily determined using a frequency measurement of an airborne sound signal. Frequency measurements can be carried out in a robust and reproducible manner and have a lower susceptibility to failure. The vibration signals preferably comprise a frequency of a structure-borne sound signal. Alternatively to an airborne sound measurement, the quality of the welded joint can be easily determined using a frequency measurement of a structure-borne sound signal. The advantage of the above-mentioned two evaluations of the frequency measurements furthermore lies in a very narrow resonance frequency in the optimized signal-to-noise ratio. For example, the factor amplitude can largely be eliminated with the evaluation of the polarity because only a square-wave signal, which depicts the frequency, is only still used, so that an amplitude change can be completely ignored.

Alternatively or additionally, the vibration signals comprise an amplitude of an airborne sound signal or an amplitude of a structure-borne sound signal. The desired information about the quality of the welded joint can be depicted in an improved manner in the amplitude information of the vibration signal or of the electric measuring signal. The information is present in a slightly more damped manner in the vibration signals because the amplitude can be influenced by different factors (overlapping through reflection, positioning of the sensor, among others). The amplitude measurements of OK workpieces can be used as training data for the AI module using a sufficiently sensitive evaluation, as described above, whereby the signal blocks are divided accordingly, so that the information, which is indicative for the quality of the welded joint, can be determined in an improved manner. For example, the factor frequency can be largely eliminated with the evaluation of the polarity because only a square-wave signal, which depicts the amplitude, is only still used, and frequency changes can be completely ignored.

Alternatively, the vibration signals result from a current or voltage measurement of a piezoelectric actuator. The current or voltage measurements of at least one piezoelectric actuator, through which the sonotrode is driven, can likewise be used easily for evaluating the information, which is indicative for the quality of the welded joint, wherein the current or voltage measurements from OK workpieces and nOK workpieces are used as training data for the AI module.

The higher harmonics of the vibration signals are preferably detected. The above-mentioned evaluations of the vibration signals are thus further sensitized, and an improved data analysis with a high resolution is possible. The higher harmonics of the vibration signals of known OK workpieces and nOK workpieces are in particular provided as training data for the AI module, so that the evaluation can be performed in an improved manner.

The higher harmonics of the vibration signals are in particular processed in step d). Not only the fundamental signal of the vibration signals can thus be processed in the FT or in the AI module, but also the signals of the higher harmonics thereof, so that a large amount of data can be evaluated based on the vibration signals, in order to compute the information, which is indicative for the quality of the welded joint, with a desired signal-to-noise ratio.

In a further embodiment, a temperature dependency of the detected vibration signals is also included at least in step g). By comparing temperature reference signals with further information in the vibration signals, a further improved statement at least about nOK workpieces can be made. Deviations, which do not have a direct impact on the information, which is indicative for the quality of the welded joint, such as, for instance changes within a certain range, which are caused by a changing temperature of the sonotrode, can be compensated by also including temperature values, measured using at least one temperature sensor. Temperature sensor can be a thermal sensor, or thermistor, or infrared sensor, and is connected to the computing device for exchanging temperature data. A rise of the temperature of the sonotrode can cause a reduction of the frequency of the sonotrode, which can cause a distorted computation of the at least one characteristic value. It can happen that the frequency of the sonotrode decreases when the temperature of the sonotrode rises. The frequency of the sonotrode at the beginning of the generation of the welded joint is thus higher than at the end. The inclusion of this temperature dependency at least in step a) improves the testing of the quality of the ultrasonic welded joint.

At least a sign of wear of the at least one component of the ultrasonic welding device is recognized with the help of the vibration signals. The at least one component can thereby comprise the welding tool, the sonotrode. A sonotrode typically enables 100,000 weldings, wherein the reliability of the welded joint on the workpiece decreases with the increasing number of the welded joint creation. It has been shown, however, that based on the evaluation mentioned above here, a prediction of the efficiency of the welding tool is possible because the comparison of the at least one characteristic value with at least one reference value changes significantly in the computing device in step f). For example, the above-mentioned analysis curve assumes an atypical course, wherein the gradient and/or the absolute values of the analysis curve change significantly, in particular decrease. It is thus possible to plan a sonotrode change at the ultrasonic welding device at an early stage, so that an unplanned failure of the ultrasonic welding device is thus avoidable.

The above-described method for testing the quality of at least one ultrasonic welded joint at a workpiece can be a computer-implemented method, wherein the computing device is a computer, which comprises at least one computing processor and a storage device. An improved, gap-free real time testing of the quality of at least one ultrasonic welded joint at the workpiece is thus possible.

A measuring apparatus according to the invention for testing the quality of at least one ultrasonic welded joint at a workpiece during the generation of the ultrasonic welded joint comprises at least one vibration pickup device for detecting vibration signals, and a computing device for comparing at least one characteristic value with at least one reference value, wherein the computing device prompts a display device to display information, which is indicative for the quality of the ultrasonic welded joint, based on the comparison of the at least one characteristic value with the at least one reference value. An above-described method can in particular be carried out using the measuring apparatus. The work behavior of an ultrasonic welding device can thus be tested continuously and automatically, in real time, and can optionally be controlled, whereby an improved quality determination of the holding force of the ultrasonic welded joint is ensured. The at least one vibration pickup device is formed to detect vibration signals.

The preferably continuously detected vibration signals can comprise airborne sound signals or structure-borne sound signals or can result from current or voltage measurements of at least one piezoelectric actuator. The vibration signals can be scanned using suitable analog-to-digital converters and can be translated into digital signal values, for example amplitude values or frequency values, which are provided to the computing device and which are transferred and stored in a storage device. The computing device is formed to compute at least one characteristic value on the basis of the at least one signal block of the electric measuring signals and to compare the at least one characteristic value to at least one reference value. The storage device is connected to the computing device for exchanging data. The computing device communicates with sensors, which record vibration signals of the ultrasonic welding device as well as of the workpiece. These can be air-coupled acoustic sensors, but also other sensors, such as structure-borne sound sensors or current/voltage sensors, which are suitable to characterize the vibration behavior of the above-described mechanical system. It is likewise possible to use several of these sensors jointly and to jointly evaluate the sensor signals thereof, in order to determine the information, which is indicative for the quality of the welded joint. Additional sensors can record parameters, such as, for instance, the temperature of the sonotrode. The sensors are connected to the computing device in order to exchange sensor data. The recording of the sensor data can be started using an electric signal, which corresponds to the activation of the generator of the ultrasonic welding device.

The vibration pickup device is preferably a microphone, so that the acoustic airborne sound signals can be detected in an improved manner. A microphone can also be positioned spaced apart from the sonotrode in the vicinity of the workpiece, so that the creation of the ultrasonic welded joint is not disturbed. The microphone is in particular an optical microphone without membrane. An optical microphone without membrane is particularly well suited as vibration pickup device because it does not have any mechanically movable components and is thus resonance-free. It is thus not influenced by the vibrations of the ultrasonic device. A membrane is forgone in the optical microphone. The optical microphone essentially comprises two parallel mirrors, between which a laser bean is arranged in interference conditions in the case of operational use of the optical microphone. The vibration signals, which arrive between the two parallel mirrors and which are sent out by the above-described mechanical resonant circuit, consisting of at least the sonotrode and the workpiece, during the ultrasonic welding process, interact with the laser beam, wherein a change of the refractive index in the sound-propagating medium between the two mirrors is caused due to the interaction of the vibration signals with the laser beam. This change or the interaction, respectively, is converted into the electric measuring signals and is detected. The electric measuring signals are further processed, as described above. The optical microphone is insensitive to electromagnetic interference fields, which are largely created, for example, using the welding device. The optical microphone is furthermore stable with respect to extremely high sound pressures, which are naturally present when metal is welded using sound waves. Both conditions are at hand in the case of the ultrasonic welding and are simultaneously strengths of the optical microphone, but also weaknesses of conventional sensors.

The optical microphone is in particular formed to detect at least two vibration signals during the creation of the ultrasonic welded joint. The vibration signals or the acoustic signals, respectively, which are relevant for monitoring the quality of the welding process, are typically radiated at different positions and in different directions by the at least one component of the ultrasonic welding device and the at least one workpiece. These positions lie several 10 centimeters away from one another, in the region of the sonotrode. It is essential for a stable and reliable quality monitoring of the welding process that all of the vibration signals or the entire acoustics, respectively, are monitored simultaneously. Due to the fact that the airborne sound and thus the vibration signals typically overlap or a superposition is present, respectively, a single optical microphone can thus monitor the entire process in a single region or at a single position, respectively, in the immediate surrounding area of the ultrasonic welding device.

Alternatively, the vibration pickup device is at least a piezoelectric vibration pickup. The current and/or voltage signals at the piezoelectric crystal are thereby converted into the electric measuring signals and are further processed, as described above.

Alternatively, the vibration pickup device is at least a capacitive vibration pickup (electrostatic microphone), in the case of which a change of the electric capacitance is converted into a voltage signal.

Alternatively, the vibration pickup device is at least an inductive vibration pickup (electrostatic microphone, electret microphone), in the case of which the change of a magnetic field is converted into a current or voltage signal, respectively.

Alternatively, the vibration pickup device is at least a structure-borne sound measuring device. The structure-borne sound signals are thereby converted into the electric measuring signals and are further processed, as described above.

In a further embodiment, at least one control device is present, which is connected to the at least one computing device and which is connected at least to the vibration pickup device for exchanging signal data and command data. The vibration pickup device can thus be controlled directly in the measuring apparatus. A computing device in particular generates control data for a control device of the ultrasonic welding device, wherein the control data can control the further transport of the workpiece. For example, the computing device can prompt the control device of the ultrasonic welding device to control a workpiece transporting device of the ultrasonic welding device in such a way that an nOK workpiece is ejected and is thus no longer used in the further processing process. Resources are thus saved.

The computing device can in particular arrange to mark an nOK workpiece using a marking device, for example using a punching device, so that said nOK workpiece is no longer used in the further processing process. Alternatively or additionally, the computing device can arrange to characterize an nOK workpiece digitally in a register of the computing device, so that said nOK workpiece is no longer used in the further processing process. Further resources are thus saved.

The control device preferably provides command data for the computing device, in order to output the indicative information at the display device. During or after the testing, the computing device can prompt the display device to display the warning signal, which represents an nOK workpiece or an OK workpiece, a user can thus immediately recognize the quality of the welded joint.

The at least one characteristic value preferably comprises at least one fluctuation value of a manufacturing process. Industrial manufacturing processes are often subject to two different variations of the manufacturing quality: A short-term, statistical fluctuation value as well as a long-term trend value. The short-term fluctuation value comprises the normal production of products, which predominantly brings forth good products and, to a small extent (e.g., in the percentage range or in the ppm range) inferior products. The second fluctuation value, in the form of a longer-term trend, means that there are days where fewer inferior products are brough forth, and other days, where more inferior products are brought forth. Such a long-term trend can be caused, for example, by a worn-out sonotrode, a fatigue process in the ultrasonic device, a mechanical wear and tear process of the support, but also through external circumstances, such as room temperature or atmospheric pressure, moisture, etc.. The long-term trend manifests itself in a seemingly frequent occurrence of nOK events. This knowledge, which is known a priori, can be utilized in the determination of the at least one characteristic value in that an OK-nOK threshold is shifted dynamically, depending on frequency of the number of nOK occurrences within a history of the past 20 or 100 weldings. The number of the viewed, past events can also be smaller, for example comprise the last 3 weldings, or can also be much larger and can comprise, for example, the last 10,000 weldings. The expansion of the evaluation software by this module described here has the result that the separation efficiency between OK and nOK can be improved, which can be of great importance for the user. The hit ratio (the correct recognition of NOK parts) can further also be improved and the wrong-right ratio (the erroneous declaration of OK part as nOK part) can be reduced, which is likewise advantageous.

A computer program according to the invention comprises commands, which, when the computer program is executed by a computer, prompts the computer to carry out an above-described method.

A computer-readable medium according to the invention comprises computer-readable instructions or commands, respectively, which, in response to the execution by a computer, prompt the latter to carry out an above-described method.

Further advantages, features, and details of the invention follow from the below description, in which exemplary embodiments of the invention are described with reference to the drawings.

The list of reference numerals as well as the technical content of the patent claims and figures is also part of the disclosure. The figures are described cohesively and comprehensively. Identical reference numerals mean identical component parts, reference numerals with different indices specify functionally identical or similar component parts.

As will be appreciated by one skilled in the art, multiple aspects described in this summary can be variously combined in different operable embodiments. All such operable combinations, though they may not be explicitly set forth in the interest of efficiency, are specifically contemplated by this disclosure.

### BRIEF DESCRIPTION OF THE DRAWINGS

The figures are described cohesively and comprehensively. Identical reference numerals mean identical component parts.

FIG. 1 shows a first method according to the invention for testing the quality of at least one ultrasonic welded joint at a workpiece.

FIG. 2 shows a vibration signal, which is detected by a vibration pickup device.

FIG. 3 shows a signal block, which is computed by the computing device.

FIG. 4 shows a further method according to the invention for testing the quality of at least one ultrasonic welded joint at a workpiece.

FIG. 5 shows a further method according to the invention for testing the quality of at least one ultrasonic welded joint at a workpiece.

FIG. 6 shows a device according to the invention for testing the quality of at least one ultrasonic welded joint at a workpiece comprising an optical microphone as vibration pickup device and comprising an ultrasonic welding device in a schematic illustration.

FIG. 7 shows a further a device according to the invention for testing the quality of at least one ultrasonic welded joint at a workpiece comprising a structure-borne sound device as vibration pickup device and comprising an ultrasonic welding device in a schematic illustration.

FIG. 8 shows a further a device according to the invention for testing the quality of at least one ultrasonic welded joint at a workpiece comprising a piezoelectric actuator as vibration pickup device and comprising an ultrasonic welding device in a schematic illustration.

FIG. 9 shows a device according to the invention according to FIG. 6 to FIG. 8 without vibration pickup device in a schematic illustration.

### DETAILED DESCRIPTION

In order to facilitate better understanding of the present invention, reference is made below to the drawings. These show only exemplary embodiments of the subject matter of the invention. These embodiments, offered not to limit but only to exemplify and teach the invention, are shown and described in sufficient detail to enable those skilled in the art to implement or practice the invention. Thus, where appropriate to avoid obscuring the invention, the description may omit certain information known to those of skill in the art. In the figures and the associated description, identical or functionally analogous parts are provided with the same reference numerals.

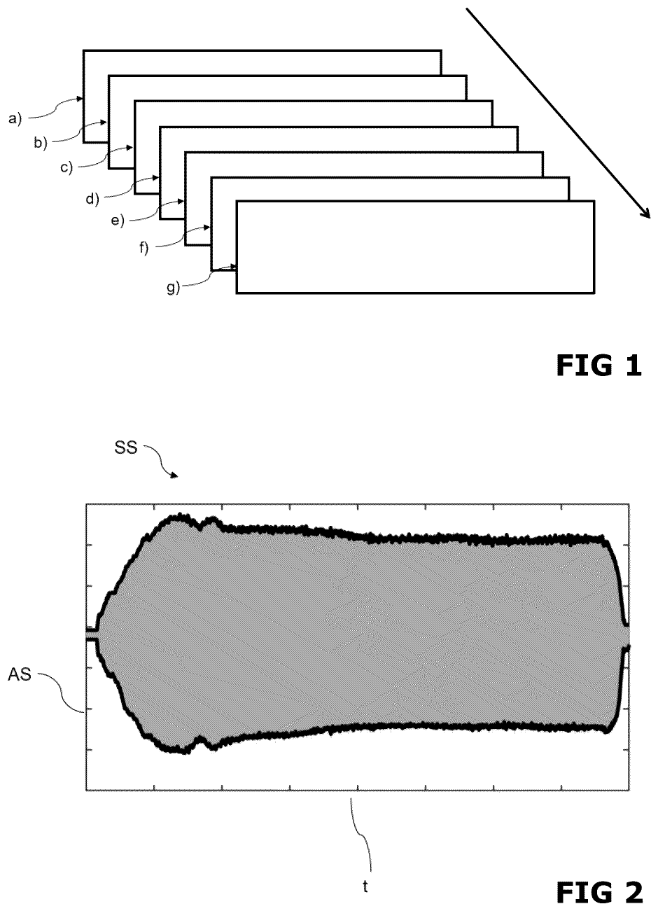

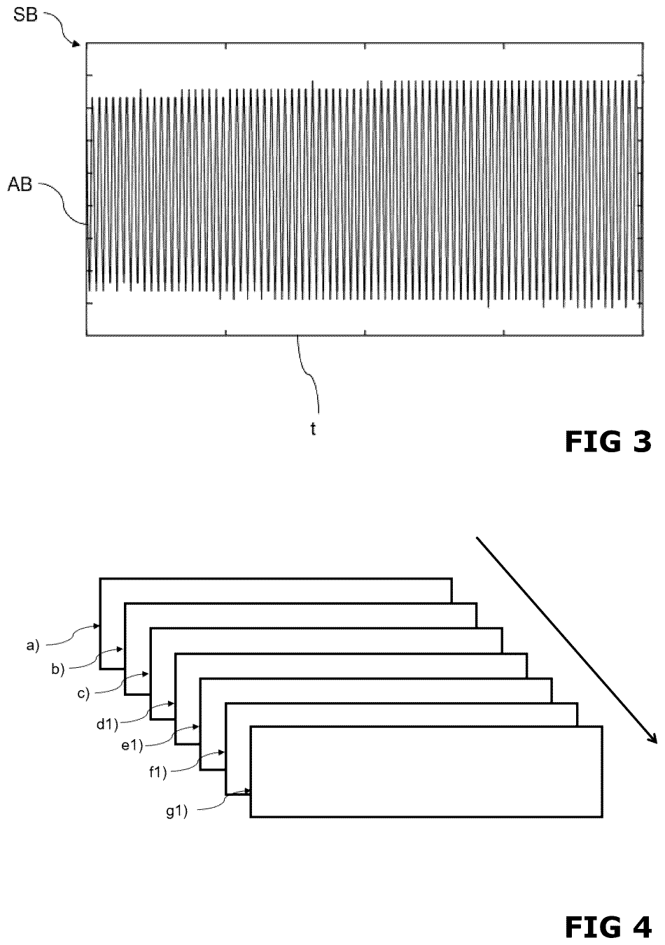

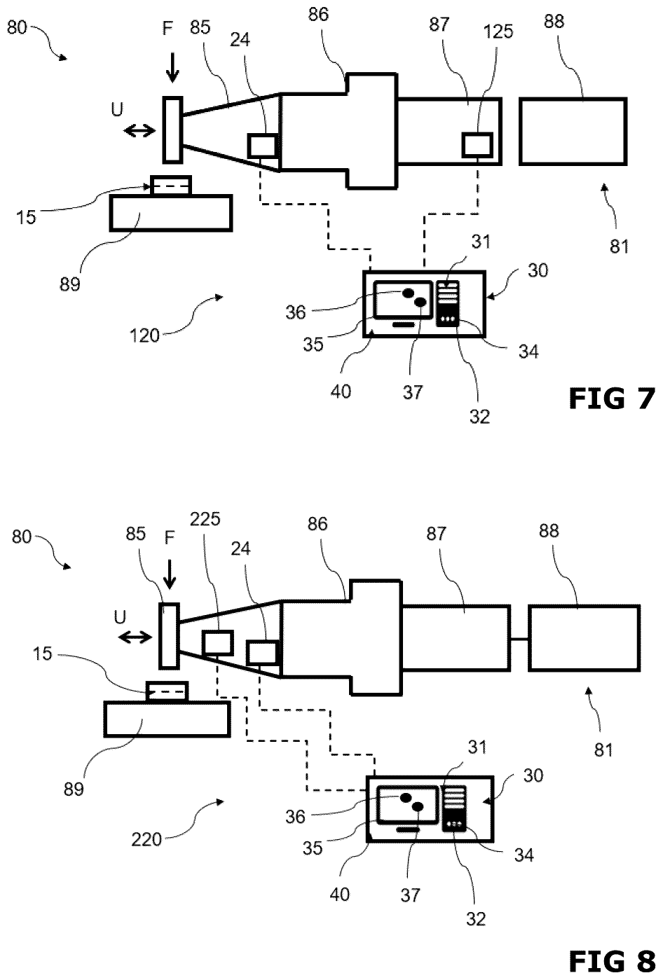

FIGS. 1 to 3 show a first embodiment of the method according to the invention for testing the quality of at least one ultrasonic welded joint during the creation of the ultrasonic welded joint at a workpiece 15, comprising a vibration pickup device 21 and a computing device 30. With regard to individual features, reference is made thereby to a measuring apparatus 20 according to the invention according to FIG. 7 in order to clearly describe the following method. The method can include at least the following steps:
a) detecting vibration signals SS using the at least one vibration pickup device 21, wherein the vibration signals SS are influenced by the sonotrode 85 of an ultrasonic welding device 80 and the workpiece 15, and, in addition to the fundamental signal of the vibration signals SS, the higher harmonics of the vibration signals SS are also detected—see the vibration signal SS in FIG. 2;
b) creating electric measuring signals EM in the vibration pickup device 21 on the basis of the detected vibration signals SS;
c) transmitting the electric measuring signals EM to the computing device 30;
d) processing at least one signal block SB of the electric measuring signals EM in the computing device 30—see a signal block SB in FIG. 3;
e) computing at least one characteristic value on the basis of the at least one signal block SB of the electric measuring signals EM;
f) comparing the at least one characteristic value with at least one reference value in the computing device 30; and
g) determining information (OK, nOK), which is indicative for the quality of the ultrasonic welded joint, based on the comparison of the at least one characteristic value with the at least one reference value.

An ultrasonic welding device 80 typically comprises a converter 87 and a sonotrode 85. For the present method, the sonotrode 85, together with the workpiece 15, forms a mechanical vibration system, which effects a shift of the fundamental frequency and of the harmonics of the vibration signals SS (typically 20 kHz as well as multiples). This shift is considered in step e) in order to determine the at least one characteristic value.

To compute the characteristic value from step e), the measuring signal can be subjected to a Hilbert transformation. A further option is the use of the coefficients of a Cepstrum transformation, but also a continuous wavelet transformation.

FIG. 2 shows a temporal course of the main sound of the vibration signal SS, which is detected using the vibration signal device 21. The time t is shown on the abscissa, and the deflection AS of the vibration signal SS on the ordinate. The deflection can be the amplitude or the frequency of the vibration signal SS.

The transmitted electric measuring signals EM are temporally scanned with the help of the computing device 30 in step b), and the polarity of the electric measuring signals EM is evaluated in the computing device 30. The electric measuring signals EM are thereby divided into binary signals, in >0 or <=0, depending on the polarity.

Properties, such as the number of the zero crossings for each time unit or a statistical evaluation of the period duration can be derived easily from the square-wave signal obtained in this way. Such properties can also be used very well as input variables for the AI module.

FIG. 3 shows a temporal course of a signal block SB. The time t is shown on the abscissa, and the deflection AB of the signal block SB on the ordinate. The deflection can be the amplitude or the frequency of the signal block SB, depending on which signal is to be evaluated in the computing device—here the frequency in this case.

The electric measuring signals EM are divided into up to two dozen signal blocks SB in step c), wherein the signal length of the individual signal blocks SB is less than 100 ms.

A Fourier transformation (FT) with the signal blocks SB is carried out in step d). The at least one signal block SB is thereby broken down into its component parts. These component parts can be individual sine waves at discrete frequencies, the amplitude and phase of which are determined. The created FT coefficients of the transformed vibration signal are used to obtain feature vectors, which serve as basis for machine leaning algorithms in AI (artificial intelligence) module 31 in the computing device 30. The AI module 31 can subsequently compute the at least one characteristic value. The AI module 31 can comprise a neuronal network or comprise a support vector machine or a transformer computing unit.

The higher harmonics of the vibration signals SS are additionally processed in step d). Not only the fundamental signal of the vibration signals SS can thus be processed in the FT or in the AI module 31, but also the higher harmonics thereof, so that a high amount of data can be evaluated based on the vibration signals SS.

After step g), an output of at least one warning signal WS takes place. A visual warning signal vWS is provided as warning signal WS, which is displayed at a display device 35 using a light signal 36. An OK workpiece or an nOK workpiece can thus be tested in real time and the result can be reported directly to a user. Alternatively or additionally, an acoustic warning signal aWS is also output at the display device 35 via a loudspeaker 37.

The above-described method for testing the quality of at least one ultrasonic welded joint during the creation of the ultrasonic welded joint at a workpiece 15 is carried out at an ultrasonic welding device 80 at several workpieces 15, wherein the workpieces 15 are arranged at a workpiece transporting device 89 and are guided one after the other to the sonotrode 85 and are further transported after the welding process.

FIG. 4 shows a further embodiment of the method according to the invention for testing the quality of at least one ultrasonic welded joint during the creation of the ultrasonic welded joint at the workpiece 15, wherein the steps a) to c) correspond to the steps according to the method of FIG. 1 to FIG. 3, and at least the following steps d1) to
g1) are provided alternatively to the steps d) to g):
d1) processing at least one signal block SB of the electric measuring signals EM in the computing device—see a signal block SB in FIG. 3;
e1) computing at least one characteristic value on the basis of the at least one signal block SB of the electric measuring signals EM;
f1) comparing the at least one characteristic value with at least one reference value in the computing device 30;
g1) determining information, which is indicative for the quality of the ultrasonic welded joint, based on the comparison of the at least one characteristic value with the at least one reference value.

The at least one signal block SB is transmitted to the AI module 31 in step d1). The at least one signal block SB is thereby used to obtain feature vectors, which serve as basis for machine learning algorithms in the AI module 31. The AI module 31 subsequently computes the at least one characteristic value. Reference measurements for welded joints of OK workpieces are generated thereby and are provided to the AI module 31 as AI training data. If classifying machine learning is used thereby and if a destructive removal test is carried out at the workpieces 15 for a number of reference measurements (with good and decreased removal force), it is thus possible to train a model with the training data obtained in this way. It is thus predicted for further vibration signals SS whether the removal force comes to lie above or below a specified threshold value. The AI module 31 can thus provide essential parameters for assessing OK or nOK workpieces. The AI module supplies a numerical value as an output, which estimates how far a measurement is in the OK (greater than zero) or NOK range (less than zero). By adding or subtracting an offset, the decision threshold can be shifted in order to set the system to be more tolerant or more sensitive in the case of an already trained model.

A tolerance range is provided in the comparison, so that several OK workpieces can be reused. The tolerance range comprises up to 10% tolerance when comparing the at least one characteristic value with the reference value, so that workpieces 15 with a deviation of up to 10% (tolerance) can still be reused as OK workpieces in the above-described comparison.

The higher harmonics of the vibration signals SS are processed in step d1). Not only the fundamental signal of the vibration signals can thus be processed in the FT or in the AI module 31, but also the higher harmonics thereof, so that a high amount of data can be evaluated based on the vibration signals.

An output of at least one warning signal WS takes place after step g1). An acoustic warning signal aWS is provided as warning signal WS, which is displayed at a display device 35 using a loudspeaker 37. An OK workpiece or an nOK workpiece can thus be tested in real time, and the result can be reported directly to a user. Alternatively or additionally, a visual warning signal vWS is also output at the display device 35 via a light signal 36.

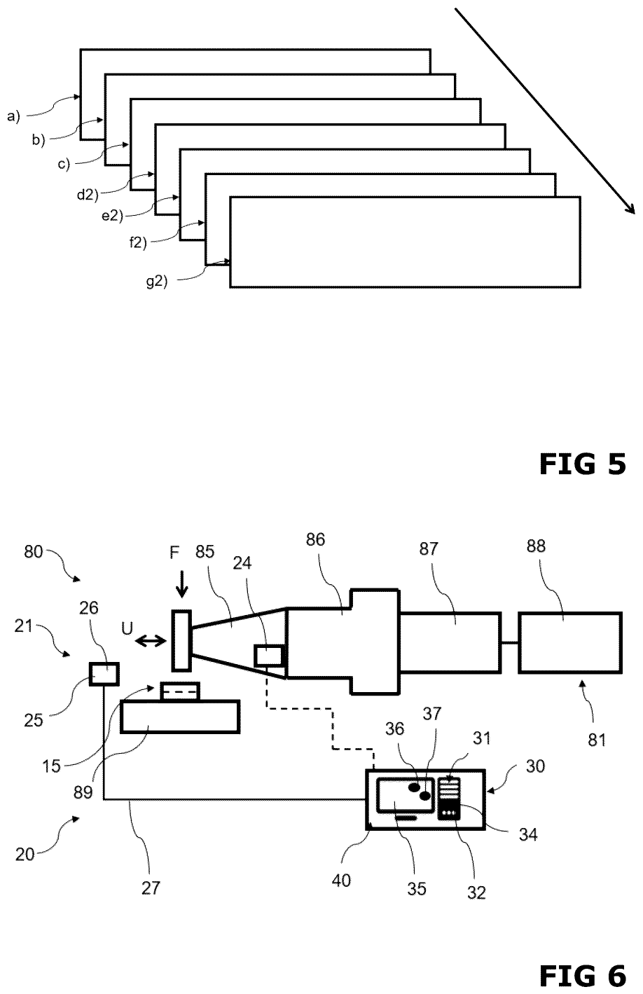

FIG. 5 shows a further embodiment of the method according to the invention for testing the quality of at least one ultrasonic welded joint during the creation of the ultrasonic welded joint at a workpiece 15, wherein the steps a) to c) correspond to the steps according to the method of FIG. 1 to FIG. 3, and at least the following steps d2) to g2) are provided alternatively to the steps d) to g):
d2) processing at least one signal block SB of the electric measuring signals EM in the computing device 30—see a signal block SB in FIG. 3;
e2) computing at least one characteristic value on the basis of the at least one signal block SB of the electric measuring signals EM;
f2) comparing the at least one characteristic value with at least one reference value in the computing device;
g2) determining information, which is indicative for the quality of the ultrasonic welded joint, based on the comparison of the at least one characteristic value with the at least one reference value.

A Fourier transformation (FT) with the signal blocks is carried out in step d2). The at least one signal block SB is thereby broken down into its component parts. These component parts can be individual sine waves at discrete frequencies, the amplitude and phase of which are determined. One or several maximum values are detected in the transformed signal block in order to reused them in particular either individually in the computing device 30 or in order to be able to provide them to the AI module 31 as training data. A maximum is thereby searched in the surrounding area (around a delta) of a signal block value SB of the transformed signal block. The higher harmonics of the vibration signals SS are additionally processed in step d3).

An analysis curve is subsequently created on the basis of the transformed signal block. The analysis curve represents a characteristic curve of the transformed signal block. The creation of a differential curve between the analysis curve and a first reference curve takes place afterwards. The first reference curve can thereby comprise data of an ultrasonic welded joint of an OK workpiece generated beforehand, so that the differential curve should have differential values around zero when the currently tested workpiece is OK.

The at least one characteristic value is subsequently generated with the help of the differential curve, wherein a decision threshold is set, in response to the exceeding of which the welding is qualified as nOK workpiece or as being faulty, respectively, or is qualified as OK workpiece or fault-free, respectively, when falling below.

A temperature dependency of the detected vibration signals is also included at least in steps g), g1), and g2) in the above-described method according to FIGS. 1 to 5, wherein the temperature is measured using a temperature sensor 24 and is transmitted to the computing device 30. The temperature influence of the current welding can thereby be compared with temperature reference values in the computing device 30 on the basis of a lookup table and can be included in the computation of the characteristic value.

A sign of wear of the sonotrode 85 of the ultrasonic welding device 80 is recognized with the help of the vibration signals SS in the above-described method according to FIGS. 1 to 5. It has been shown that, based on the evaluations mentioned above here, a prediction of the efficiency of the sonotrode 85 is possible because the comparison of the at least one characteristic value with at least one reference value changes significantly in the computing device 30 in steps f1, f2), or f3). For example, the AI module 31 analyses deviating characteristic values or the above-mentioned analysis curve takes on an unwanted course, wherein the gradient and/or the absolute values of the analysis curve change significantly, in particular decrease. These changes are different from the values of the analysis curves or are different from the characteristic values of an nOK workpiece, so that the signs of wear can be recognized at the sonotrode 85. It is thus possible to plan a sonotrode change at the ultrasonic welding device 80 early on, so that an unplanned failure of the ultrasonic welding device 80 is thus avoidable.

Depending on the embodiment and depending on the used vibration pickup device 21, the continuously detected vibration signals SS in the above-described methods can comprise airborne sound signals or structure-borne sound signals or can result from current or voltage measurements of at least one piezoelectric actuator.

FIG. 6 shows a first embodiment of the measuring apparatus 20 according to the invention for testing the quality of at least one ultrasonic welded joint at a workpiece 15 during the creation of the ultrasonic welded joint. The measuring apparatus 20 comprises at least one optical microphone 25 as vibration pickup device 21 and a computing device 30, wherein the computing device 30 prompts a display device 35 to display information OK, nOK, which is indicative for the quality of the ultrasonic welded joint. The measuring apparatus 20 carries out one of the above-describe methods according to FIGS. 1 to 5.

The optical microphone 25 is formed to detect at least two or all vibration signals SS, respectively, during the creation of the ultrasonic welded joint. Due to the fact that the airborne sound and thus the vibration signals SS mix up, a single optical microphone 25 can thus monitor the entire welding process at a single position in the immediate surrounding area of the ultrasonic welding device 80.

The ultrasonic welding device 80 has an anvil, on which the originally two-part workpiece 15 is arranged, and a sonotrode 85, which is pushed onto the workpiece 15 through a contact pressure F, and which sends out ultrasonic waves U normally to the force of the contact pressure F. The sonotrode 85 is connected with the help of a booster 86 and the converter 87 to an electric generator 88 and is driven therewith.

The optical microphone 25 is arranged in the immediately vicinity of the workpiece 15, spaced apart from the sonotrode 85, wherein the vibration signals SS detected at the optical microphone 25 are acoustic airborne sound signals. The optical microphone 25 essentially comprises a detection head 26 comprising two parallel mirrors, between which a laser beam L is arranged in interference conditions in the case of operational use of the optical microphone 25. The laser beam L is guided from the detection head 26 all the way to the computing device 30 using an optical fiber 27 in order to further process the laser beam signal. The acoustic airborne sound signals, which arrive between the two parallel mirrors and which are sent out by the sonotrode 85 and the workpiece 15 during the ultrasonic welding process, interact with the laser beam L, wherein a change of the refractive index in the sound-propagating medium between the two mirrors in the detection head 26 is caused due to the interaction of the acoustic airborne sound signals with the laser beam L. The laser beam signals are converted into electric measuring signals EM. The latter are thereby scanned using suitable analog-to-digital converters and are translated into digital signal values, for example amplitude values or frequency values, which are transferred to the computing device 30 and to a storage device 34 and are stored.

The electric measuring signals EM are further processed, as described above. The optical microphone 25 is connected to the computing device 30 for exchanging sensor data and control data. The storage device 34 is connected to the computing device 30 for exchanging data. The digital signal values are translated into a binary signal in the computing device 30, in that an evaluation of the scanning values in >0 or <=0 is carried out.

A temperature sensor 24, which measures the temperature of the sonotrode, is arranged at the sonotrode 85. The temperature sensor 24 is electrically connected to the computing device 30 for exchanging sensor data. The recording of the sensor data can be started using an electric signal, which corresponds to the activation of the generator 88 of the ultrasonic welding device 80.

A control device 40 is present, which is connected to the at least one computing device 30 and which is connected at least to the optical microphone 25 for exchanging signal data and command data. The computing device 30 generates control data for a control device 81 of the ultrasonic welding device 80, wherein the control data control the further transport of the workpiece 15 at a workpiece transporting device 89. For example, the computing device 30 prompts the control device 81 to control the workpiece transporting device 89 in such a way that an nOK workpiece 15 is ejected and is thus no longer used in the further processing process.

The control device 40 provides command data for the computing device 30 in order to output the indicative information at a display device 35. During or after testing the workpiece 15, the computing device 30 prompts the display device 35 to visually and/or acoustically display a warning signal WS as described above, which represents an nOK workpiece or an OK workpiece.

FIG. 7 shows a second embodiment of the measuring apparatus 120 according to the invention for testing the quality of at least one ultrasonic welded joint at a workpiece 15 during the creation of the ultrasonic welded joint. The measuring apparatus 120 comprises at least one structure-borne sound sensor 125 as vibration pickup device 21 and a computing device 30, wherein the computing device 30 prompts a display device 35 to display information OK, nOK, which is indicative for the quality of the ultrasonic welded joint. The measuring apparatus 120 carries out one of the above-described methods according to FIGS. 1 to 5.

The structure-borne sound sensor 125 is arranged on the sonotrode 85, wherein the vibration signals SS detected at the structure-borne sound sensor 125 are mechanical vibration signals. The structure-borne sound signals are thereby converted into the electric measuring signals EM and are further processed as in the above-described methods.

FIG. 8 shows a further embodiment of the measuring apparatus 220 according to the invention for testing the quality of at least one ultrasonic welded joint at a workpiece 15 during the creation of the ultrasonic welded joint. The measuring apparatus 120 comprises at least one piezoelectric sensor or a capacitive sensor or an inductive sensor 225 as vibration pickup device 21 and a computing device 30, wherein the computing device 30 prompts a display device 35 to display information OK, nOK, which is indicative for the quality of the ultrasonic welded joint. The measuring apparatus 220 carries out one of the above-described methods according to FIGS. 1 to 5. The current and/or voltage signals are thereby converted at the least one sensor 225 into the electric measuring signals EM and are further processed as in the above-described methods.

It is likewise possible in the above-described measuring apparatus 20, 120, 220 to jointly use several identical or different vibration pickup device 21 and to jointly evaluate the sensor signals thereof, in order to determine the information, which is indicative for the quality of the welded joint.

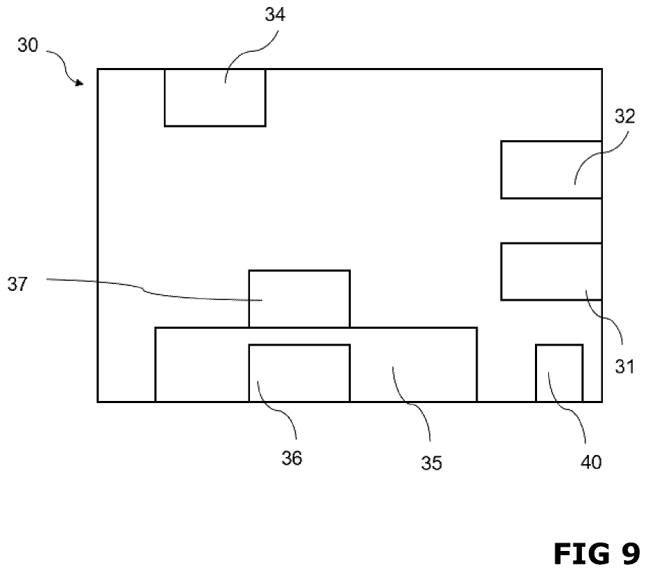

FIG. 9 shows the above-described computing device 30 as computer, comprising a computer-readable medium comprising computer-readable instructions or commands, respectively, which, during the execution by a computer, prompt the latter to carry out one of the above-described methods. The computer comprises at least one computing processor 32 and a storage device 34 and is optionally connected to the AI module 31. The above-described methods for testing the quality of at least one ultrasonic welded joint at a workpiece according to one of FIGS. 1 to 5 can be embodied as a computer-implemented method.

### REFERENCE LIST

15 Workpiece
20 Measuring apparatus
21 Vibration pickup device
24 Temperature sensor
25 Optical microphone
26 Detection head
27 Optical fiber
30 Computing device
31 AI module
32 Computing processor
34 Storage device
35 Display device
36 Light signal
37 Loudspeaker
40 Control device
80 Ultrasonic welding device
81 Control device of 80
85 Sonotrode
86 Booster
87 Converter
88 Generator
89 Workpiece transporting device
120 Measuring apparatus
125 Structure-borne sound sensor
220 Measuring apparatus
225 Sensor
L Laser beam
SS Vibration signal
AS Deflection of SS
EM Electric measuring signals
t Time
f Frequency
SB Signal block
OK Indicative information—reusable workpiece
nOK Indicative information—non-reusable workpiece (represents not OK)
FT Fast Fourier transformation
WS Warning signal
aWS Acoustic warning signal
vWS Visual warning signal
U Ultrasound
F Contact pressure

### Conclusion

Although the subject matter has been described in terms of certain embodiments, other embodiments that may or may not provide various features and aspects set forth herein shall be understood to be contemplated by this disclosure. The specific embodiments set forth herein are disclosed as examples only, and the scope of the patented subject matter is defined by the claims that follow.

The invention also encompasses individual features shown in the figures, even if they are shown there in connection with other features and/or are not mentioned above. Further, the term “comprising”, and derivatives thereof do not exclude other elements or steps. Likewise, the indefinite article “a” or “one” and derivatives thereof do not exclude a plurality. The functions of multiple features recited in the claims may be performed by a single unit. The terms “substantially”, “approximately”, “about” and the like in connection with a characteristic or a value define, in particular, also exactly the characteristic or exactly the value. All reference signs in the claims are not to be understood as limiting the scope of the claims. In method claims, any reference characters are used for convenience of description only, and do not indicate a particular order for performing a method.

1. A method for testing a quality of an ultrasonic welded joint during creation of the ultrasonic welded joint using at least one vibration pickup device and a computing device, the method comprising:
detecting vibration signals using the at least one vibration pickup device, wherein the vibration signals are influenced by at least one component of an ultrasonic welding device and at least one workpiece;
creating electric measuring signals in the vibration pickup device based on the detected vibration signals;
transmitting the electric measuring signals to the computing device;
processing at least one signal block of the electric measuring signals in the computing device;
computing at least one characteristic value on the basis of the at least one signal block of the electric measuring signals;
comparing the at least one characteristic value with at least one reference value in the computing device;
determining information indicative of the quality of the ultrasonic welded joint based on the comparison of the at least one characteristic value with the at least one reference value; and
outputting of a warning signal based on the determined information.

2. The method of claim 1, wherein at least two vibration signals are detected in a single region or a single position, wherein said single region or single position is spaced apart from the at least one component of the ultrasonic welding device and the at least one workpiece.

3. The method of claim 1, wherein the transmitted electric measuring signals are temporally scanned using the computing device.

4. The method of claim 1, wherein the electric measuring signals are divided into signal blocks.

5. The method of claim 1, further comprising:
performing a Fourier transformation on the processed at least one signal block; and
transmitting the transformed at least one signal block to an AI module or a regression module.

6. The method of claim 5, wherein one or more maximum values in transformed at least one signal block are detected, and an analysis curve is created based on the transformed at least one signal block.

7. The method of claim 1, further comprising:
performing a Hilbert transformation on the processed at least one signal block; and
transmitting the transformed at least one signal block to an AI module or a regression module.

8. The method of claim 1, further comprising:
performing a Cepstrum transformation on the processed at least one signal block; and
transmitting the transformed at least one signal block to an AI module or a regression module.

9. The method of claim 8, wherein one or more maximum values in transformed at least one signal block are detected, and an analysis curve is created based on the transformed at least one signal block.

10. The method of claim 9, wherein a differential curve is created between the analysis curve and a first reference curve.

11. The method of claim 1, wherein the vibration signals comprise a frequency of an airborne sound signal or of a structure-borne sound signal, or the vibration signals result from a current or voltage measurement.

12. The method of claim 1, wherein the vibration signals comprise an amplitude of an airborne sound signal or of a structure-borne sound signal, or wherein the vibration signals result from a current or voltage measurement.

13. The method of claim 1, wherein higher harmonics of the vibration signals are detected.

14. The method of claim 1, wherein a temperature dependency of the detected vibration signals is included.

15. The method of claim 1, wherein at least a sign of wear of the at least one component of the ultrasonic welding device is recognized based on the vibration signals.

16. A non-transitory computer readable medium having instructions stored thereon, wherein the instructions are executed by a computer to perform the method of claim 1.

17. A measuring apparatus for testing a quality of an ultrasonic welded joint of a workpiece during generation of the ultrasonic welded joint, the apparatus comprising:
at least one vibration pickup device for detecting vibration signals; and
a computing device for comparing at least one characteristic value based on the vibration signals with at least one reference value, said computing device is connected to the at least one vibration pickup device,
wherein the computing device is configured to cause a display device to display information indicative of the quality of the ultrasonic welded joint based on the comparing of the at least one characteristic value with the at least one reference value.

18. The measuring apparatus of claim 17, wherein the vibration pickup device is an optical microphone, a piezoelectric vibration pickup, or a structure-borne sound measuring device.

19. The measuring apparatus of claim 17, further comprising at least one control device, the at least one control device being connected to the at least one computing device and to the vibration pickup device for exchanging signal data and reference data.

20. The measuring apparatus of claim 19, wherein the control device provides command data for the computing device in order to output the indicative information on the display device.
